(19) United States
(12) Patent Application Publication
(10) Pub. No.: US 2009/0078864 A1
(43) Pub. Date: Mar. 26, 2009

(54) Molecular sieves

(75) Inventor: Jonathan Marcel Gowers, Berghers Hill (GB)

Correspondence Address: FOLEY AND LARDNER LLP;SUITE 500, 3000 K STREET NW, WASHINGTON, DC, 20007, US

(73) Assignee: Smiths Detection-Watford Limited

(21) Appl. No.: 11/918,897

(22) PCT Filed: Apr. 20, 2006
(86) PCT No.: PCT/GB2006/001440

§ 371 Date: Oct. 19, 2007

(30) Foreign Application Priority Data
Apr. 28, 2005 (GB) 0508636.8

(51) Int. Cl. H01J 49/00; C01B 39/00; C04B 38/06; B01J 19/08

(52) U.S. Cl. 250/288; 423/700; 264/628; 427/457

(57) ABSTRACT

A molecular sieve (20) for an IMS is formed of a solid block (24) of zeolite within a closely fitting housing (21). The block (24) has multiple passages (25) to (28) through which gas can flow along the block. The block (24) may be made by casting or extrusion and the sieve material may include a dopant.

This invention relates to molecular sieves.

The invention is more particularly concerned with molecular sieves for use in ion mobility spectrometers (IMSs) and other detection apparatus.

Molecular sieves are used in IMSs and other detection apparatus to remove unwanted chemicals from gas supplied to the detection apparatus. The molecular sieve may include a dopant substance, such as in the manner described in U.S. Pat. No. 6,825,460. Usually the molecular sieve is provided by a large number of spheres, about 2 mm in diameter, of a zeolite material packed into an outer housing connected in the gas flow path. Gas flowing through the pack follows a tortuous path around the outside of the spheres with some of the gas flowing through the spheres. These molecular sieve packs can be effective at a relatively low cost but have the disadvantage of being relatively bulky. This is not a problem in many apparatus but can be a problem where apparatus is to be of a small size, such as for being carried about the person.

It is an object of the present invention to provide an alternative molecular sieve.

According to one aspect of the present invention there is provided a molecular sieve characterised in that the sieve is formed of a solid block of molecular sieve material provided with a multiplicity of gas passages extending through it.

The gas flow through the sieve is preferably substantially confined to flow through the interior of the block.

According to a second aspect of the present invention there is provided a molecular sieve unit including an outer housing and a molecular sieve material within the housing, characterised in that the sieve material is provided by a solid block of molecular sieve material having an external shape matched to the internal shape of the housing.

The block of molecular sieve material preferably has a multiplicity of gas passages extending through it. The molecular sieve material may be of zeolite and may include a dopant.

According to a third aspect of the present invention there is provided a method of forming a molecular sieve including the steps of providing a slurry of a sieve material, forming it into a solid block having a multiplicity of gas passages extending therethrough, and placing the block in an outer housing.

The slurry may be formed into the solid block by moulding into a block shape and then subjecting it to heat to form a solid block. Alternatively, the slurry may be formed into a solid block by extruding the slurry and then subjecting it to heat to form a solid block.

According to a fourth aspect of the present invention there is provided a method of forming a block of molecular sieve material including the steps of providing a powder of the molecular sieve material, depositing successive layers of the powder, subjecting selected regions of the deposited layers to energy sufficient to bind the powder together in the selected regions such as to provide a solid block of molecular sieve material with gas passages extending through it.

According to a fifth aspect of the present invention there is provided a molecular sieve block formed by a method according to the above third or fourth aspect of the present invention.

According to a sixth aspect of the present invention there is provided detection apparatus including an inlet for entry of a sample gas into a chamber, a gas flow arrangement for admitting gas to the chamber via a molecular sieve, and an electrical output for providing an indication of the presence of a substance within the gas, characterised in that the molecular sieve includes a solid block of molecular sieve material provided with a multiplicity of gas paths extending through it.

The chamber may be an ion mobility drift chamber.

IMS apparatus including a molecular sieve according to the present invention will now be described, by way of example, with reference to the accompanying drawings, in which:

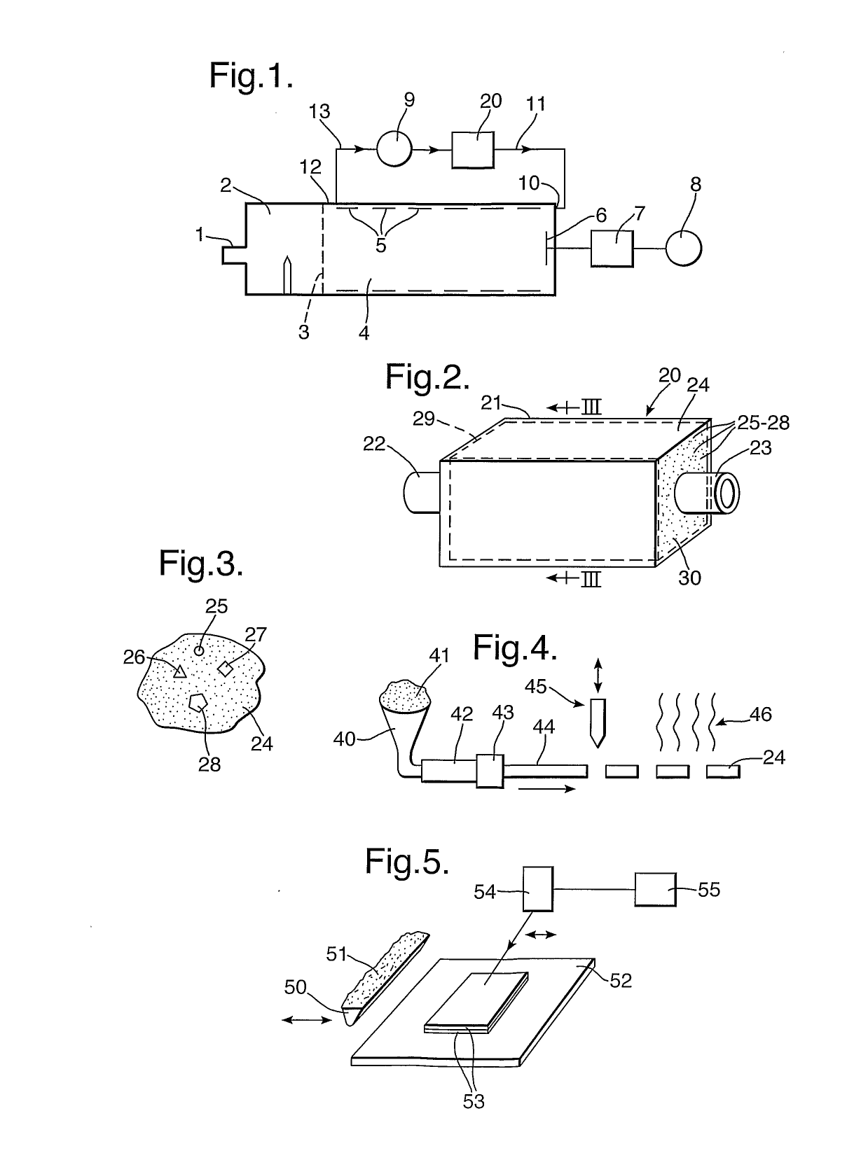

FIG. 1 shows the apparatus schematically;

FIG. 2 is a perspective view of the molecular sieve;

FIG. 3 is an enlarged section of the molecular sieve along the line III-III showing a variety of different shape gas passages;

FIG. 4 illustrates an extrusion technique by which the molecular sieve can be made; and

FIG. 5 illustrates an alternative selective laser sintering technique for making the molecular sieve.

With reference first to FIG. 1, the spectrometer has an inlet 1 by which airborne chemicals and vapours enter the instrument and pass to an ionization chamber 2, where they are ionized. A gate 3 admits the ions to the left-hand end of a drift chamber 4 where they are caused to flow to the right-hand end by a voltage field applied to electrodes 5. Ions are collected on a collector plate 6 where they are detected and provide an output to a processing unit 7, which in turn provides an output representative of the nature of the chemical to a display 8 or other utilisation means. A pump 9 circulates drift gas through the drift chamber 4 against the flow of the ions, that is, from right to left. The outlet side of the pump 9 connects with an inlet 10 towards right-hand end of the drift chamber via tubing 11 and a molecular sieve unit 20. The inlet side of the pump 9 connects with an outlet 12 towards the left-hand end of the drift chamber 4, via tubing 13.

With reference now to FIGS. 2 and 3, the molecular sieve unit 20 comprises an outer plastics housing 21 of rectangular section and having an inlet opening 22 at one end and an outlet opening 23 at the opposite end. The sieve unit 20 also includes a single, solid block 24 of a sintered zeolite material effective to act as a molecular sieve material. The block 24 has the same shape as the inside of the housing 21 and is formed with multiple gas passages 25 to 28 extending parallel to one another along the length of the block and opening onto opposite end faces 29 and 30. The gas passages may be of any regular or irregular sectional shape, such as circular 25, triangular 26, square 27 or hexagonal 28. The cross-sectional area and length of the gas passages 25 to 28 are chosen such that the block 24 achieves the desired degree of removal of unwanted substances. Gas passages 25 to 28 with a small cross-section and a long length remove a greater amount of unwanted substances but present a higher impedance to gas flow. The block 24 forms a gas-tight seal with the inside of the housing so that gas is confined to flow through the interior of the block 24. This gas-tight seal could be achieved by means of a separate sealing component (not shown) between the outside of the block and the inside of the housing 21. The end faces 29 and 30 of the block 24 are spaced slightly from the ends of the housing 21 such as to ensure efficient gas flow over the entire end faces of the block. Alternatively, the inside ends of the housing 21 or the end faces of the block 24 could be profiled to achieve the desired degree of channeling of gas.

It will be appreciated that the sieve could be of various different shapes and need not be rectangular in section. The sieve could be long and thin or short and fat. Various alternative materials as well as zeolites could be used as the molecular sieve material. The molecular sieve need not be provided by a single block but could be provided by several blocks, which could be arranged side-by-side or end-to-end.

It is believed that the block form of sieve could achieve the same performance as a pack of loose zeolite spheres but with a volume that could be up to about 30% smaller than the conventional pack. Alternatively, a block molecular sieve of the same volume as a pack of spheres could be provided if it was necessary to increase the efficiency of the molecular sieve. A further advantage of the solid block construction is that it might be possible clean the sieve block using chemicals or a thermal treatment in order to reuse the block when it becomes contaminated. The solid sieve block could include a dopant in the manner described in U.S. Pat. No. 6,825,460.

Although the block 24 of sieve material can be made in various ways, it is preferably made by the extrusion technique shown in FIG. 4. A hopper 40 contains a slurry 41 of zeolite powder and a liquid, such as water, which is supplied to an extrusion head 42. The head 42 includes a die 43 defining both the external shape and the internal gas passages 25 to 28 through the finished block. The extrudate 44 emerges from the head 42 as a continuous rod, this is then cut to length at the cutting station 45 and baked to sinter the blocks at a heat treatment stage 46. This extrusion process enables blocks of various shapes to be formed at low cost. The finished block is placed in an outer housing having an internal shape matching the external shape of the block.

Alternatively, the blocks could be formed simply by moulding in moulds including pins to define the gas passages. In another technique, the blocks could be moulded or otherwise formed with elements of a material that can be subsequently be removed. These elements could be in the form of thin rods of a material that melts away during the sintering process, or of a material that can be dissolved away in a solvent, such as water.

A further alternative technique of making the blocks is illustrated in FIG. 5, which shows selective laser sintering apparatus where successive layers of a zeolite powder are deposited and selected regions of the deposited layers are subjected to energy sufficient to bind the powder together. The apparatus has a hopper 50 containing zeolite powder 51, which is moved backwards and forwards over a substrate 52 to deposit successive thin layers 53 of the powder. A high-energy laser scanner 54 controlled by a processor 55 and located above the substrate 52 directs a beam of energy down onto selected regions of the deposited layers 53. The energy of the beam is sufficient to bond the powder particles to one another in the regions on which the radiation is incident. In regions where the powder is not subject to radiation, the powder remains loose and is removed (such as by means of a jet of air) between successive layers or at the end of the technique. The gas passages through the block are, therefore, formed by those regions that are not bonded by the laser beam. In this way, it would be possible to provide relative complex, tortuous gas paths in three dimensions through the block. If the energy provided by the laser beam is not sufficient to cause sintering of the zeolite powder particles, the zeolite powder could be mixed with a binder material that produces a bond when subjected to the laser energy, The block produced in such a manner could then be treated later at a higher temperature in a furnace to complete the sintering and drive off the binder.

In the arrangement described above the housing and sieve block are separate components. It would be possible, however, to add the zeolite material to a plastics material to produce a unitary device. In this way, it might be possible to incorporate the sieve material into, for example, the thickness of the wall of the housing of a detector apparatus.

The present invention is not confined to IMS apparatus but could be used in other detector apparatus.

1. A molecular sieve, characterised in that the sieve is formed of a solid block (24) of molecular sieve material provided with a multiplicity of gas passages (25 to 28) extending through it.

2. A molecular sieve according to claim 1, characterised in that gas flow through the sieve (20) is substantially confined to flow through the interior of the block (24).

3. A molecular sieve unit (20) including an outer housing (21) and a molecular sieve material within the housing, characterised in that the sieve material is provided by a solid block (24) of molecular sieve material having an external shape matched to the internal shape of the housing (21).

4. A molecular sieve unit (20) according to claim 3, characterised in that the block (24) of molecular sieve material has a multiplicity of gas passages (25 to 28) extending through it.

5. A molecular sieve or sieve unit according to claim 1, characterised in that the molecular sieve material (24) is of zeolite.

6. A molecular sieve or sieve unit according to claim 1, characterised in that the molecular sieve material (24) includes a dopant.

7. A method of forming a molecular sieve including the steps of providing a slurry (41) of a sieve material, forming it into a solid block (24) having a multiplicity of gas passages (25 to 28) extending therethrough, and placing the block in an outer housing (21).

8. A method according to claim 7, characterised in that the slurry is formed into the solid block by moulding into a block shape and then subjecting it to heat to form a solid block.

9. A method according to claim 7, characterised in that the slurry (41) is formed into a solid block by extruding the slurry and then subjecting it to heat to form a solid block (24).

10. A method of forming a block (24) of molecular sieve material including the steps of providing a powder (51) of the molecular sieve material, depositing successive layers (53) of the powder, subjecting selected regions of the deposited layers to energy sufficient to bind the powder together in the selected regions such as to provide a solid block of molecular sieve material with gas passages (25 to 28) extending through it.

11. A molecular sieve block (24) formed by a method according to claim 7.

12. Detection apparatus including an inlet (1) for entry of a sample gas into a chamber (4), a gas flow arrangement (9, 20, 11) for admitting gas to the chamber via a molecular sieve (20), and an electrical output (6) for providing an indication of the presence of a substance within the gas, characterised in that the molecular sieve includes a solid block (24) of molecular sieve material provided with a multiplicity of gas paths (25 to 28) extending through it.

13. Detection apparatus according to claim 12, characterised in that the chamber is an ion mobility drift chamber (4).
